(19) United States
(12) Patent Application Publication
(10) Pub. No.: US 2025/0273957 A1
(43) Pub. Date: Aug. 28, 2025

(54) HYBRID LOAD-ENERGY STORAGE SYSTEM APPLICABLE TO MICROGRID OF HYDROMETALLURGICAL PLANT, AND CONTROL METHOD THEREFOR

(71) Applicant: Tianjin University, Tianjin (CN)

(72) Inventors: Xiandong XU, Tianjin (CN); Yuze ZHAO, Tianjin (CN); Longfei LIU, Tianjin (CN); Jing LIU, Tianjin (CN); Manjun CHEN, Tianjin (CN); Yunfei MU, Tianjin (CN); Hongjie JIA, Tianjin (CN)

(73) Assignee: Tianjin University, Tianjin (CN)

(21) Appl. No.: 19/207,792

(22) Filed: May 14, 2025

(30) Foreign Application Priority Data
Aug. 19, 2024 (CN) 202411138659.3

(51) Int. Cl. H02J 3/00; H02J 3/28; H02J 3/38; H02J 13/00

(52) U.S. Cl. CPC H02J 3/001; H02J 3/28; H02J 3/381; H02J 13/00004; H02J 13/00036; H02J 2310/12

(57) ABSTRACT

A hybrid load-energy storage system applicable to a microgrid of a hydrometallurgical plant, includes: a plurality of first electrical equipment, a plurality of second electrical equipment, first energy storage equipment, and second energy storage equipment. An electric usage priority of the first electrical equipment is lower than that of the second electrical equipment. The first energy storage equipment is on-grid and off-grid energy storage equipment, and the second energy storage equipment is grid-forming energy storage equipment. The first electrical equipment is connected to the first energy storage equipment via branches provided with first circuit breakers, and the second electrical equipment is connected to the second energy storage equipment via branches provided with second circuit breakers. The first second energy storage equipment are respectively connected to an AC bus via branches provided with a third and a fourth circuit breakers, and the AC bus is connected to an external power grid.

### CROSS-REFERENCE TO RELATED APPLICATIONS

This application claims priority to Chinese Patent Application No. 202411138659.3 with a filing date of Aug. 19, 2024. The content of the aforementioned application, including any intervening amendments thereto, is incorporated herein by reference.

### TECHNICAL FIELD

The present disclosure relates to the field of microgrids, and in particular, to a hybrid load-energy storage system applicable to a microgrid of a hydrometallurgical plant, and a control method therefor.

### BACKGROUND

During plant operation, there may be power cuts due to a shortage of power supply from the external power grid, resulting in isolated grid operation. It takes a long time to restart large-scale plant equipment after a shutdown. For example, after a large-scale asynchronous machine used for industrial production in a hydrometallurgical plant is shut down, there is still a certain amount of material inside the equipment such as a ball mill and a crusher towed by the machine at the rear end, and thus restarting the machine after the shutdown requires complex technical processes such as machine turning, inverter motor input, increase of the speed, and putting into production with load.

In the prior art, energy storage systems can be configured for factories with unstable power supply. Conventional on-grid and off-grid energy storage systems have certain power supply risks in the actual production process. When the power supply of the external power grid is reduced but not completely lost, the voltage and frequency support provided by the external power grid can be used to participate in the energy supply and distribution of the plant microgrid. However, when the external power grid completely loses the power supply capacity, it takes a certain amount of time for self-contained generator sets in the plant to start and connect to the grid, and thus high-energy-consuming machinery will shut down directly during this period of time, causing serious safety hazards or resulting in serious economic and property losses. In other words, the energy storage system configuration in the prior art cannot ensure the production operation of the plant after the power supply from the external power grid of the plant is interrupted.

### SUMMARY

The present disclosure provides a hybrid load-energy storage system applicable to a microgrid of a hydrometallurgical plant, and a control method therefor, so as to solve the defect in the prior art that plant production cannot be guaranteed after the power supply from the external power grid of the plant is interrupted, and to ensure plant production after the power supply from the external power grid of the plant is interrupted.

The present disclosure provides a hybrid load-energy storage system applicable to a microgrid of a hydrometallurgical plant, including: a plurality of first electrical equipment, a plurality of second electrical equipment, first energy storage equipment, and second energy storage equipment, where an electric usage priority of the first electrical equipment is lower than that of the second electrical equipment, the first energy storage equipment is on-grid and off-grid energy storage equipment, and the second energy storage equipment is grid-forming energy storage equipment;
each of the plurality of first electrical equipment is connected to the first energy storage equipment via a branch provided with a first circuit breaker, the plurality of second electrical equipment are connected to the second energy storage equipment via a branch provided with a second circuit breaker, the first energy storage equipment is connected to an AC bus via a branch provided with a third circuit breaker, the second energy storage equipment is connected to the AC bus via a branch provided with a fourth circuit breaker, the AC bus is connected to an external power grid, the plurality of first electric equipment are connected to the AC bus via branches provided with fifth circuit breakers, and the plurality of second electric equipment are connected to the AC bus via branches provided with sixth circuit breakers.

The present disclosure provides a control method for the hybrid load-energy storage system applicable to a microgrid of a hydrometallurgical plant, including: in a case where the external power grid is powered off, controlling the third circuit breaker and the sixth circuit breakers to be opened and the second circuit breakers and the third circuit breaker to be closed;
controlling the opening and closing of the fifth circuit breakers corresponding to the first electrical equipment based on a power failure priority of the first electric equipment, where the power failure priority reflects the degree of influence of the power failure of the first electrical equipment on plant production; and
upon the second energy storage equipment providing stable voltage and frequency support, controlling the third circuit breaker to be closed.

According to the control method for the hybrid load-energy storage system applicable to a microgrid of a hydrometallurgical plant provided by the present disclosure, in a case where the external power grid is not powered off, the third circuit breaker, the fourth circuit breaker, the fifth circuit breakers and the sixth circuit breakers are kept closed, and the first circuit breakers and the second circuit breakers are kept opened.

According to the control method for the hybrid load-energy storage system applicable to a microgrid of a hydrometallurgical plant provided by the present disclosure, controlling the opening and closing of the fifth circuit breakers corresponding to the first electrical equipment based on the power failure priority of the first electrical equipment includes:
in a case where the power failure priority of the first electrical equipment is a first power failure priority, controlling the fifth circuit breakers corresponding to the first electrical equipment to be closed, and controlling the first electrical equipment to reduce the load within a range of process requirements;
in a case where the power failure priority of the first electrical equipment is a second power failure priority, controlling the fifth circuit breakers corresponding to the first electrical equipment to be closed, and controlling the first electrical equipment to partially shut down; and
in a case where the power failure priority of the first electrical equipment is a third power failure priority, controlling the fifth circuit breakers corresponding to the first electrical equipment to be opened, where
the degree of influence of the power failure of the electrical equipment corresponding to the first power failure priority on production is greater than that corresponding to the second power failure priority, and the degree of influence of the power failure of the electrical equipment corresponding to the second power failure priority on production is greater than that corresponding to the third power failure priority.

According to the control method for the hybrid load-energy storage system applicable to a microgrid of a hydrometallurgical plant provided by the present disclosure, upon controlling the third circuit breaker to be closed, the method includes:
upon synchronizing the voltage and frequency of the first energy storage equipment with those of the second energy storage equipment, controlling the first circuit breakers of the first electrical equipment corresponding to the fifth circuit breakers that are closed to be closed, and the fifth circuit breakers that are closed to be opened.

According to the control method for the hybrid load-energy storage system applicable to a microgrid of a hydrometallurgical plant provided by the present disclosure, upon controlling the third circuit breaker to be closed, the method includes:
reducing the supply power of the second energy storage equipment to match the energy consumption of the second electrical equipment.

The present disclosure also provides a control device for the hybrid load-energy storage system applicable to a microgrid of a hydrometallurgical plant, including:
a power failure instant control module, configured to, in a case where the external power grid is powered off, control the third circuit breaker and the sixth circuit breakers to be opened and the second circuit breakers and the third circuit breaker to be closed;
a first electrical equipment control module, configured to control the opening and closing of the fifth circuit breakers corresponding to the first electrical equipment based on a power failure priority of the first electrical equipment, where the power failure priority reflects the degree of influence of the power failure of the first electrical equipment on plant production; and
an energy storage synergy module, configured to, upon the second energy storage equipment providing stable voltage and frequency support, control the third circuit breaker to be closed.

The present disclosure also provides an electronic device, including a memory, a processor, and a computer program stored in the memory and executable on the processor, where the processor, when executing the computer program, implements the control method for the hybrid load-energy storage system applicable to a microgrid of a hydrometallurgical plant as described in any of the above.

The present disclosure also provides a non-transitory computer-readable storage medium having a computer program stored thereon, which, when executed by a processor, implements the control method for the hybrid load-energy storage system applicable to a microgrid of a hydrometallurgical plant as described in any of the above.

The present disclosure also provides a computer program product, including a computer program, which, when executed by a processor, implements the control method for the hybrid load-energy storage system applicable to a microgrid of a hydrometallurgical plant as described in any of the above.

According to the hybrid load-energy storage system applicable to a microgrid of a hydrometallurgical plant, and the control method therefor provided by the present disclosure, by dividing the electrical equipment in the plant into first electrical equipment and second electric equipmental according to electric usage priorities, grid-forming second energy storage equipment is directly configured for the second electrical equipment with a higher electric usage priority, and conventional on-grid and off-grid first energy storage equipment is directly configured for the first electrical equipment with a lower electric usage priority. Each of the plurality of first electrical equipment is connected to the first energy storage equipment via a branch provided with a first circuit breaker, and each of the plurality of second electric equipment is connected to the second energy storage equipment via a branch provided with a second circuit breaker. The first energy storage equipment is connected to an AC bus via a branch provided with a third circuit breaker, and the second energy storage equipment is connected to the AC bus via a branch provided with a fourth circuit breaker. The AC bus is connected to an external power grid. The plurality of first electrical equipment are connected to the AC bus via branches provided with fifth circuit breakers, and the plurality of second electrical equipment are connected to the AC bus via branches provided with sixth circuit breakers. In the event of a power failure on the external power grid of the plant, the grid-forming energy storage equipment can be started quickly and preferentially after the power failure through the opening and closing of each circuit breaker, so as to provide voltage and frequency support for the plant power grid in a shorter time, and provide power supply to more important electrical equipment in priority at the same time. Upon the grid-forming energy storage equipment providing stable power and frequency, the on-grid and off-grid energy storage equipment is connected to the power grid through the opening and closing of the circuit breakers to provide power support, thereby achieving the effect of ensuring the plant production after the power supply from the external power grid of the plant is interrupted.

### BRIEF DESCRIPTION OF THE DRAWINGS

In order to more clearly illustrate the technical solutions in the present disclosure or the prior art, the following briefly introduces the accompanying drawings required for use in the embodiments or the description of the prior art. Obviously, the accompanying drawings described below are some embodiments of the present disclosure. For those of ordinary skill in this field, other accompanying drawings can be obtained based on these accompanying drawings without paying creative work.

FIG. 1 is a first wiring schematic diagram of a hybrid load-energy storage system applicable to a microgrid of a hydrometallurgical plant provided by the present disclosure.

FIG. 2 is a second wiring schematic diagram of the hybrid load-energy storage system applicable to a microgrid of a hydrometallurgical plant provided by the present disclosure.

FIG. 3 is a a flowchart of a control method for the hybrid load-energy storage system applicable to a microgrid of a hydrometallurgical plant provided by the present disclosure.

FIG. 4 is a schematic structural diagram of a control device for the hybrid load-energy storage system applicable to a microgrid of a hydrometallurgical plant provided by the present disclosure.

FIG. 5 is a schematic structural diagram of an electronic device provided by the present disclosure.

### DETAILED DESCRIPTION

In order to make the purpose, technical solutions and advantages of the present disclosure clearer, the technical solutions of the present disclosure will be clearly and completely described below in conjunction with the accompanying drawings in the present disclosure. Obviously, the described embodiments are part of the embodiments of the present disclosure, rather than all of the embodiments. Based on the embodiments of the present disclosure, all other embodiments obtained by those of ordinary skill in the field without making any creative work shall fall within the scope of protection of the present disclosure.

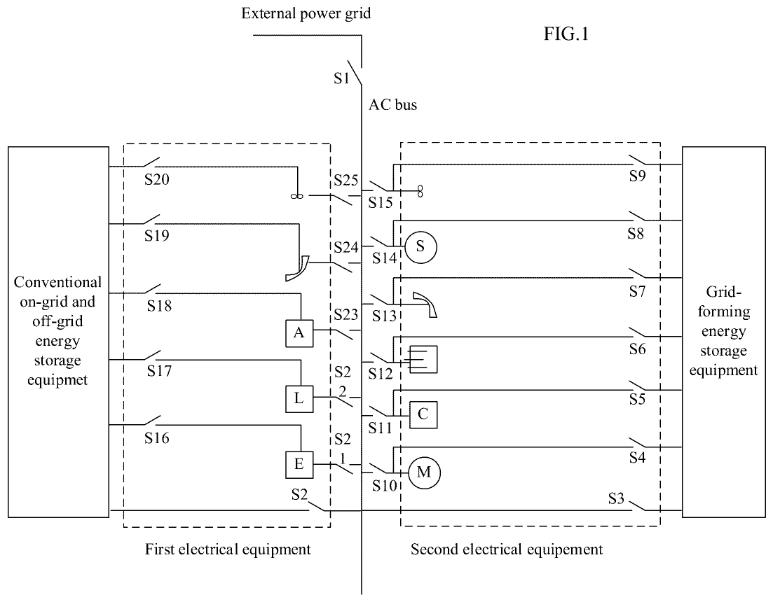

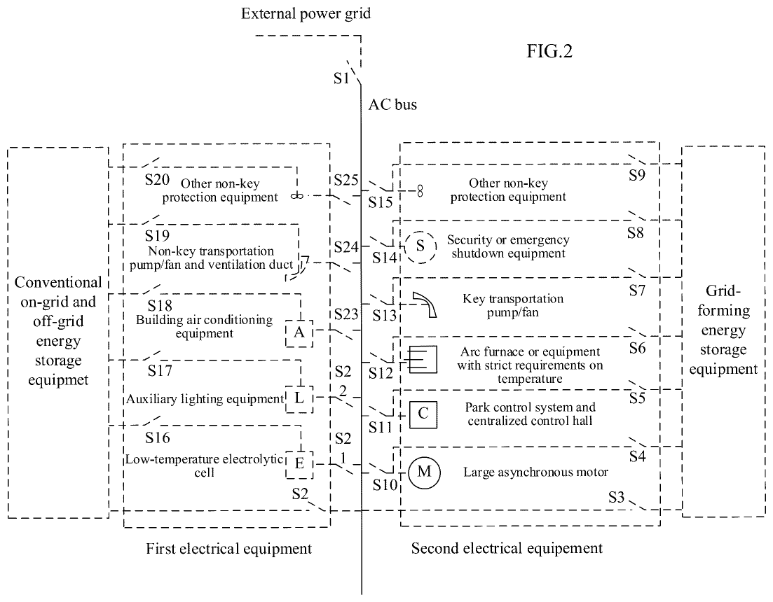

The hybrid load-energy storage system applicable to a microgrid of a hydrometallurgical plant provided by the present disclosure is described as follows in conjunction with FIG. 1. As shown in FIG. 1, the hybrid load-energy storage system applicable to a microgrid of a hydrometallurgical plant provided by the present disclosure includes a plurality of first electrical equipment, a plurality of second electrical equipment, first energy storage equipment (the conventional on-grid and off-grid energy storage equipment in FIG. 1), and second energy storage equipment (the grid-forming energy storage equipment in FIG. 1). The first electrical equipment and the second electrical equipment are divided based on electric usage priorities, and the electric usage priority of the first electrical equipment is lower than that of the second electrical equipment. Specifically, the electrical equipment included in the plant microgrid may be divided into first electrical equipment and second electrical equipment according to the electric usage priorities in the plant production process. The second electrical equipment is production equipment that should be protected first in the plant production process, and the first electrical equipment is non-key protection equipment in production. In other words, the loss caused by power failure of the first electrical equipment will be greater than that caused by power failure of the second electrical equipment. As shown in FIG. 2, in a hydrometallurgical plant, the second electrical equipment may be large asynchronous motors, centralized control halls and control systems in the park, arc furnaces and other equipment with strict requirements on temperature changes, transportation pipelines for key production materials and their associated pumps or fans, security systems and emergency shutdown systems in the production process in the park, etc.; the first electrical equipment may be low-temperature electrolytic cells that have no strict requirements on temperature changes and have a certain system inertia, auxiliary lighting equipment within the plant, air conditioning and ventilation pipelines that have no direct impact on actual production and their associated fans/water coolers or heating equipment, material transportation pipelines that have no serious impact on the plant production process after starting, stopping or reducing load and their associated pumps or fans, etc.

In the system provided by the present disclosure, the first electrical equipment may be directly connected to the first energy storage equipment through first circuit breakers (S16-S20 in FIG. 1), and the second electrical equipment may be directly connected to the second energy storage equipment through second circuit breakers (S4-S9 in FIG. 1). That is to say, grid-forming energy storage is configured for the second electrical equipment, and conventional on-grid and off-grid energy storage is configured for the first electrical equipment. Since the cost of grid-forming energy storage is relatively high, the system provided by the present disclosure can reduce the initial investment and construction cost of the energy storage systems in the plant.

Further, the first energy storage equipment is connected to an AC bus via a branch provided with a third circuit breaker (S2 in FIG. 1), the second energy storage equipment is connected to the AC bus via a branch provided with a fourth circuit breaker (S3 in FIG. 1), the first electrical equipment is connected to the AC bus via branches provided with fifth circuit breakers (S21-S25 in FIG. 1), and the second electrical equipment is connected to the AC bus via branches provided with sixth circuit breakers (S10-S15 in FIG. 1).

In the event of a power failure on the external power grid of the plant, the grid-forming energy storage equipment can be started quickly and preferentially after the power failure through the opening and closing of each circuit breaker, and dominate the power supply of the plant microgrid, so as to provide voltage and frequency support for the plant power grid in a shorter time, and provide power supply to more important electrical equipment in priority at the same time. Upon the grid-forming energy storage equipment providing stable power and frequency, the on-grid and off-grid energy storage equipment is connected to the power grid through the opening and closing of the circuit breakers to provide power support. The grid-forming energy storage equipment assists the conventional on-grid and off-grid energy storage equipment for startup and commissioning, which effectively maintains the operation of important electrical equipment and other auxiliary machines in the plant through the cooperation of both pieces of equipment, thereby ensuring the plant production after the power failure on the external power grid.

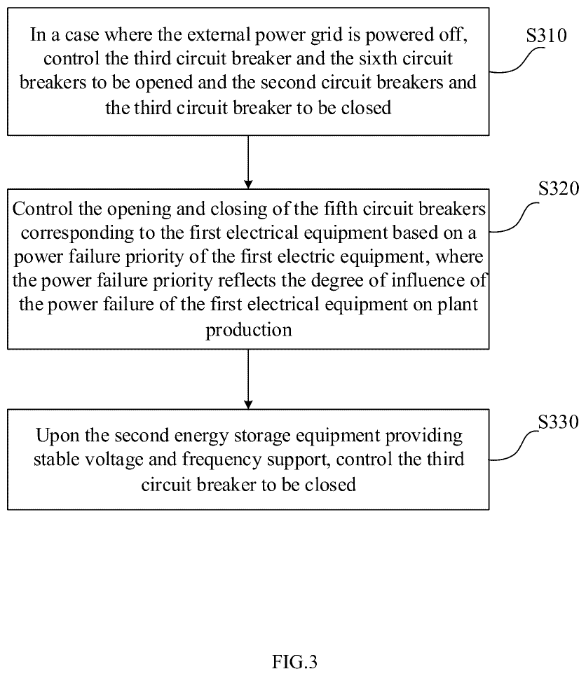

The control method for the hybrid load-energy storage system applicable to a microgrid of a hydrometallurgical plant provided by the present disclosure is described as follows in conjunction with FIG. 3. As shown in FIG. 3, the control method for the hybrid load-energy storage system applicable to a microgrid of a hydrometallurgical plant provided by the present disclosure includes the steps of:

S310, In a case where the external power grid is powered off, control the third circuit breaker and the sixth circuit breakers to be opened and the second circuit breakers and the third circuit breaker to be closed;

S320, Control the opening and closing of the fifth circuit breakers corresponding to the first electrical equipment based on a power failure priority of the first electric equipment, where the power failure priority reflects the degree of influence of the power failure of the first electrical equipment on plant production; and

S330, Upon the second energy storage equipment providing stable voltage and frequency support, control the third circuit breaker to be closed.

As shown in FIG. 1, a circuit breaker is provided between the AC bus and the external power grid. When the external power grid is not switched off, the circuit breaker is closed, and various pieces of electrical equipment in the plant microgrid are directly powered by the external power grid through the AC bus by controlling the remaining circuit breakers to be opened and closed. That is, when the external power grid is not powered off, the third circuit breaker, the fourth circuit breaker, the fifth circuit breakers and the sixth circuit breakers are kept closed, and the first circuit breakers and the second circuit breakers are kept opened. When the external power grid is not powered off, the first energy storage equipment and the second energy storage equipment perform energy storage charging.

When the external power grid is powered off, the circuit breaker between the AC bus and the external power grid is immediately disconnected, and the third circuit breaker and the sixth circuit breakers are immediately controlled to be opened, while the second circuit breakers and the third circuit breaker are kept closed. In this way, the second energy storage equipment can be quickly put into power supply to ensure the operation of the second electrical equipment; while the first electrical equipment can be switched off or partially shut down or continued to operate according to the actual situation.

Specifically, controlling the opening and closing of the fifth circuit breakers corresponding to the first electrical equipment based on the power failure priority of the first electrical equipment includes:
in a case where the power failure priority of the first electrical equipment is a first power failure priority, controlling the fifth circuit breakers corresponding to the first electrical equipment to be closed, and controlling the first electrical equipment to reduce the load within a range of process requirements;
in a case where the power failure priority of the first electrical equipment is a second power failure priority, controlling the fifth circuit breakers corresponding to the first electrical equipment to be closed, and controlling the first electrical equipment to partially shut down; and
in a case where the power failure priority of the first electrical equipment is a third power failure priority, controlling the fifth circuit breakers corresponding to the first electrical equipment to be opened, where
the degree of influence of the power failure of the electrical equipment corresponding to the first power failure priority on production is greater than that corresponding to the second power failure priority, and the degree of influence of the power failure of the electrical equipment corresponding to the second power failure priority on production is greater than that corresponding to the third power failure priority.

As shown in FIG. 2, equipment that does not require high sensitivity to power changes and has a certain inertia, such as a low-temperature electrolytic cell, can be considered to have a first power failure priority, and can be reduced to the minimum load within the scope of process requirements. The corresponding fifth circuit breakers are kept closed so that such equipment can draw power through the second energy storage equipment. Equipment that can be partially shut down, such as auxiliary lighting equipment, can be considered to have a second power failure priority. The corresponding fifth circuit breakers are kept closed, and the equipment is shut down according to the minimum baseline standard, so that the amount of power drawn is limited although such equipment can draw power through the second energy storage equipment. For example, for auxiliary lighting equipment, a part of basic lighting can be reserved to maintain normal operation of personnel in the plant, and the rest of lighting can be shut down. Equipment that has no impact on production when shutting down, such as a building air conditioner, can be considered to have a third power failure priority. The corresponding fifth circuit breakers are controlled to be opened so that such equipment cannot draw power through the second energy storage equipment. By dividing the first electrical equipment into more detailed parts, the plant production can be more effectively ensured when power is supplied through the second energy storage equipment during a power failure.

The second energy storage equipment can quickly provide power supply for the plant microgrid. Upon the second energy storage equipment establishing stable voltage and frequency support, that is, the degree of voltage and frequency output fluctuation of the second energy storage equipment being lower than a preset set value, the third circuit breaker is closed so that the first energy storage equipment can obtain a basic voltage and frequency reference, so as to make corresponding voltage and frequency output.

Upon controlling the third circuit breaker to be closed, the control method provided by the present disclosure further includes:
upon synchronizing the voltage and frequency of the first energy storage equipment with those of the second energy storage equipment, controlling the first circuit breakers of the first electrical equipment corresponding to the fifth circuit breakers that are closed to be closed, and the fifth circuit breakers that are closed to be opened.

Upon synchronizing the voltage and frequency of the first energy storage equipment to be consistent with those of the second energy storage equipment, the fifth circuit breakers corresponding to the first electrical equipment drawing power from the second energy storage equipment through the AC bus are opened, and the first circuit breakers directly connected to the first energy storage equipment are closed at the same time.

Further, upon synchronizing the voltage and frequency of the first energy storage equipment to be consistent with those of the second energy storage equipment, the supply power of the second energy storage equipment can be reduced since the first energy storage equipment can participate in power supply, so that a power supply frequency domain of the second energy storage equipment matches the energy consumption of the second electric equipment, thereby preferentially ensuring that the power of the second energy storage equipment is supplied to the second electrical equipment.

Upon stable operation of the first energy storage equipment, an electric usage state of the first electric equipment can be adjusted. Specifically, the electric usage state of the first electrical equipment with the first power failure priority is adjusted first to control the first priority equipment to increase the load and operate normally. Then, the first electrical equipment with the second power failure priority that is shut down is restored depending on the power reserve situation of the first energy storage equipment. Finally, in a case where there is still power reserve in the first energy storage equipment, the first circuit breakers of all or part of the first electrical equipment with the third power failure priority are closed.

By means of the method provided by the present disclosure, in the event of a power failure on the external power grid of the plant, the grid-forming energy storage equipment is started, the first electrical equipment is partially shut down or its operating power is reduced, and the grid-forming energy storage equipment is waiting to establish voltage and frequency support according to a frequency coordination waiting mechanism of the on-grid and off-grid energy storage equipment led by the grid-forming energy storage equipment. Upon the grid-forming energy storage equipment establishing its voltage and frequency support, the conventional on-grid and off-grid energy storage equipment is put into use, and the power of the first electrical equipment is gradually restored as required. In this process, gradual control is carried out according to the power reduction of the first electric equipment and a synchronous power increase mechanism of the on-grid and off-grid energy storage equipment. Finally, under the basic conditions such as power and capacity of the configured overall energy storage equipment, the plant achieves maximum efficient operation and waits for the external power grid to restore power supply.

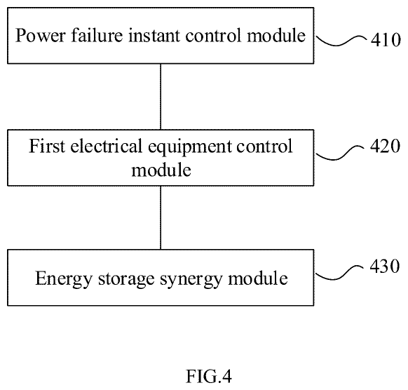

The control device for the hybrid load-energy storage system applicable to a microgrid of a hydrometallurgical plant provided by the present disclosure is described below. The control device for the hybrid load-energy storage system applicable to a microgrid of a hydrometallurgical plant described below and the control method for the hybrid load-energy storage system applicable to a microgrid of a hydrometallurgical plant described above can be referred to each other. As shown in FIG. 4, the control device for the hybrid load-energy storage system applicable to a microgrid of a hydrometallurgical plant provided by the present disclosure includes the following modules:
a power failure instant control module 410, configured to, in a case where the external power grid is powered off, control the third circuit breaker and the sixth circuit breakers to be opened and the second circuit breakers and the third circuit breaker to be closed;
a first electrical equipment control module 420, configured to control the opening and closing of the fifth circuit breakers corresponding to the first electrical equipment based on a power failure priority of the first electrical equipment, where the power failure priority reflects the degree of influence of the power failure of the first electrical equipment on plant production; and
an energy storage synergy module 430, configured to, upon the second energy storage equipment providing stable voltage and frequency support, control the third circuit breaker to be closed.

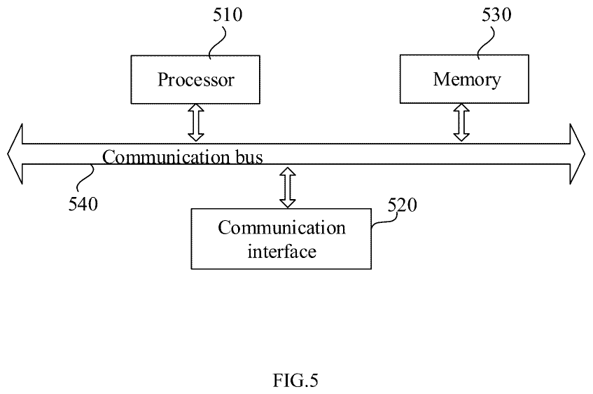

FIG. 5 illustrates a schematic diagram of a physical structure of an electronic device. As shown in FIG. 5, the electronic device may include: a processor 510, a communication interface 520, a memory 530, and a communication bus 540, where the processor 510, the communication interface 520 and the memory 530 communicate with each other via the communication bus 540. The processor 510 may call logic instructions in the memory 530 to execute a control method for a hybrid load-energy storage system applicable to a microgrid of a hydrometallurgical plant. The method includes: in a case where the external power grid is powered off, controlling the third circuit breaker and the sixth circuit breakers to be opened and the second circuit breakers and the third circuit breaker to be closed; controlling the opening and closing of the fifth circuit breakers corresponding to the first electrical equipment based on a power failure priority of the first electrical equipment, where the power failure priority reflects the degree of influence of the power failure of the first electrical equipment on plant production; and upon the second energy storage equipment providing stable voltage and frequency support, controlling the third circuit breaker to be closed.

In addition, the logic instructions in the above memory 530 may be implemented in the form of software functional units and when sold or used as independent products, may be stored in a computer-readable storage medium. Based on such understanding, the technical solutions of the present disclosure essentially, or the part that contributes to the prior art, or the part of the technical solution, can be embodied in the form of a software product. The computer software product is stored in a storage medium and includes a number of instructions for enabling a computer device (which may be a personal computer, a server, or a network device, etc.) to perform all or part of the steps of the method described in each embodiment of the present disclosure. The aforementioned storage media include: USB flash drives, mobile hard disks, read-only memories (ROM), random access memories (RAM), magnetic disks or optical disks, and other media that can store program codes.

On the other hand, the present disclosure also provides a computer program product including a computer program, which can be stored on a non-transitory computer-readable storage medium. When the computer program is executed by a processor, the computer can execute the control method for a hybrid load-energy storage system applicable to a microgrid of a hydrometallurgical plant provided by the above methods. The method includes: in a case where the external power grid is powered off, controlling the third circuit breaker and the sixth circuit breakers to be opened and the second circuit breakers and the third circuit breaker to be closed; controlling the opening and closing of the fifth circuit breakers corresponding to the first electrical equipment based on a power failure priority of the first electrical equipment, where the power failure priority reflects the degree of influence of the power failure of the first electrical equipment on plant production; and upon the second energy storage equipment providing stable voltage and frequency support, controlling the third circuit breaker to be closed.

On the other hand, the present disclosure also provides a non-transitory computer-readable storage medium having a computer program stored thereon, which, when executed by a processor, is implemented to execute the control method for a hybrid load-energy storage system applicable to a microgrid of a hydrometallurgical plant provided by the above methods. The method includes: in a case where the external power grid is powered off, controlling the third circuit breaker and the sixth circuit breakers to be opened and the second circuit breakers and the third circuit breaker to be closed; controlling the opening and closing of the fifth circuit breakers corresponding to the first electrical equipment based on a power failure priority of the first electric equipment, where the power failure priority reflects the degree of influence of the power failure of the first electrical equipment on plant production; and upon the second energy storage equipment providing stable voltage and frequency support, controlling the third circuit breaker to be closed.

The device embodiments described above are merely illustrative, in which the units described as separate components may or may not be physically separated, and the components displayed as units may or may not be physical units, that is, they may be located in one place or distributed over a plurality of units. Some or all of the modules may be selected according to actual needs to achieve the purpose of the solution in this embodiment. Those of ordinary skill in the art can understand and implement the present disclosure without any creative effort.

Through the description of the above implementations, those skilled in the art can clearly understand that each implementation can be implemented by means of software plus a necessary general hardware platform, and can also be implemented by hardware certainly. Based on this understanding, the above technical solutions essentially or the part that contributes to the prior art can be embodied in the form of a software product. The computer software product can be stored in a computer-readable storage medium, such as ROM/RAM, a disk, an optical disk, etc., and includes a number of instructions for enabling a computer device (which can be a personal computer, a server, or a network device, etc.) to execute the methods described in each embodiment or certain parts of the embodiments.

Finally, it should be noted that the above embodiments are merely used to illustrate, rather than limiting, the technical solutions of the present disclosure. Although the present disclosure has been described in detail with reference to the aforementioned embodiments, those of ordinary skill in the art should understand that they can still modify the technical solutions described in the aforementioned embodiments, or make equivalent replacements for part of the technical features therein; and these modifications or replacements do not deviate the essence of the corresponding technical solutions from the spirit and scope of the technical solutions of the embodiments of the present disclosure.

What is claimed is:

1. A hybrid load-energy storage system applicable to a microgrid of a hydrometallurgical plant, wherein the hybrid load-energy storage system comprises: a plurality of first electrical equipment, a plurality of second electrical equipment, first energy storage equipment, and second energy storage equipment, wherein an electric usage priority of the first electrical equipment is lower than an electric usage priority of the second electrical equipment, the first energy storage equipment is on-grid and off-grid energy storage equipment, and the second energy storage equipment is grid-forming energy storage equipment;
each of the plurality of first electrical equipment is connected to the first energy storage equipment via a branch provided with a first circuit breaker, each of the plurality of second electrical equipment is connected to the second energy storage equipment via a branch provided with a second circuit breaker, the first energy storage equipment is connected to an alternating current (AC) bus via a branch provided with a third circuit breaker, the second energy storage equipment is connected to the AC bus via a branch provided with a fourth circuit breaker, the AC bus is connected to an external power grid, the plurality of first electrical equipment are connected to the AC bus via branches provided with fifth circuit breakers, and the plurality of second electrical equipment are connected to the AC bus via branches provided with sixth circuit breakers.

2. A control method based on the hybrid load-energy storage system applicable to a microgrid of a hydrometallurgical plant of claim 1, wherein the method comprises:
in a case where the external power grid is powered off, controlling the third circuit breaker and the sixth circuit breakers to be opened and the second circuit breakers and the third circuit breaker to be closed;
controlling the opening and closing of the fifth circuit breakers corresponding to the first electrical equipment based on a power failure priority of the first electrical equipment, wherein the power failure priority reflects the degree of influence of the power failure of the first electric equipment on plant production; and
upon the second energy storage equipment providing stable voltage and frequency support, controlling the third circuit breaker to be closed.

3. The control method according to claim 2, wherein in a case where the external power grid is not powered off, the third circuit breaker, the fourth circuit breaker, the fifth circuit breakers and the sixth circuit breakers are kept closed, and the first circuit breakers and the second circuit breakers are kept opened.

4. The control method according to claim 2, wherein controlling the opening and closing of the fifth circuit breakers corresponding to the first electrical equipment based on the power failure priority of the first electrical equipment comprises:
in a case where the power failure priority of the first electrical equipment is a first power failure priority, controlling the fifth circuit breakers corresponding to the first electrical equipment to be closed, and controlling the first electrical equipment to reduce the load within a range of process requirements;
in a case where the power failure priority of the first electrical equipment is a second power failure priority, controlling the fifth circuit breakers corresponding to the first electrical equipment to be closed, and controlling the first electrical equipment to partially shut down; and
in a case where the power failure priority of the first electrical equipment is a third power failure priority, controlling the fifth circuit breakers corresponding to the first electrical equipment to be opened, wherein
the degree of influence of the power failure of the electrical equipment corresponding to the first power failure priority on production is greater than that corresponding to the second power failure priority, and the degree of influence of the power failure of the electrical equipment corresponding to the second power failure priority on production is greater than that corresponding to the third power failure priority.

5. The control method according to claim 2, wherein upon controlling the third circuit breaker to be closed, the method comprises:
upon synchronizing the voltage and frequency of the first energy storage equipment with those of the second energy storage equipment, controlling the first circuit breakers of the first electrical equipment corresponding to the fifth circuit breakers that are closed to be closed, and the fifth circuit breakers that are closed to be opened.

6. The control method according to claim 2, wherein upon controlling the third circuit breaker to be closed, the method comprises:
reducing the supply power of the second energy storage equipment to match the energy consumption of the second electrical equipment.

7. A control device based on the hybrid load-energy storage system applicable to a microgrid of a hydrometallurgical plant of claim 1, wherein the device comprises:
a power failure instant control module, configured to, in a case where the external power grid is powered off, control the third circuit breaker and the sixth circuit breakers to be opened and the second circuit breakers and the third circuit breaker to be closed;
a first electrical equipment control module, configured to control the opening and closing of the fifth circuit breakers corresponding to the first electrical equipment based on a power failure priority of the first electrical equipment, wherein the power failure priority reflects the degree of influence of the power failure of the first electrical equipment on plant production; and
an energy storage synergy module, configured to, upon the second energy storage equipment providing stable voltage and frequency support, control the third circuit breaker to be closed.

8. An electronic device, comprising a memory, a processor, and a computer program stored in the memory and executable on the processor, wherein the processor, when executing the computer program, implements the control method according to claim 2.

9. A non-transitory computer-readable storage medium having a computer program stored thereon, wherein the computer program, when executed by a processor, implements the control method according to claim 1.

10. A computer program product, comprising a computer program, wherein the computer program, when executed by a processor, implements the control method according to claim 2.
